(19) United States
(12) Patent Application Publication
(10) Pub. No.: US 2017/0174489 A1
(43) Pub. Date: Jun. 22, 2017

(54) SAFETY STEP

(71) Applicants: Greg Jeter, Copan, OK (US); Jon Geeo, Bartlesville, OK (US); Jack Sroufe, Bartlesville, OK (US)

(72) Inventors: Greg Jeter, Copan, OK (US); Jon Geeo, Bartlesville, OK (US); Jack Sroufe, Bartlesville, OK (US)

(21) Appl. No.: 15/380,426

(22) Filed: Dec. 15, 2016

Related U.S. Application Data
(60) Provisional application No. 62/268,380, filed on Dec. 16, 2015.

(51) Int. Cl. B66F 11/04

(52) U.S. Cl. CPC B66F 11/044

(57) ABSTRACT

A step for safety buckets and other machinery and structures where slippage and/or electrical conductivity can be an issue is provided. Additionally, a method of construction the step is disclosed. The step comprises a base portion and a series of projections. The base portion is substantially flat and has an upper surface and a lower surface. The series of projections extends upward from said upper surface. The base portion and the projections are formed of a material that is rigid and non-conductive.

### CROSS-REFERENCE TO RELATED APPLICATION

This application claims the benefit of U.S. Provisional Application No. 62/268,380 filed Dec. 16, 2015, which is hereby incorporated by reference.

### FIELD

The present disclosure relates generally to non-slip and non-skid steps, and more specifically, to non-slip steps on buckets or aerial baskets for bucket trucks and similar vehicles.

### BACKGROUND

Today's linemen are provided with the latest “state of the art” accessories for working aloft in “aerial baskets,” or bucket trucks. They are equipped with pneumatic tools, hydraulic jibs with winches, pistol grip controls, fiberglass booms, insulated liners, and much more. These life and work saving devices are needed and appreciated by electrical lineman, communication workers, and forestry services everywhere.

Over the years, one item of great importance has seen little or no change. With the growing popularity of bucket trucks, the step for entering and exiting the bucket is getting more attention. Slip and fall accidents are on the rise. Non-skid tape no longer provides sufficient traction, especially in inclement weather, or at night, when heavy workloads can cause fatigue and distractions. For instance, while removing or putting the bucket cover on, the worker is on average, tiptoeing on only 70 sq. inches.

### SUMMARY

In accordance with one series of embodiments of the current disclosure, there is provided a step comprising a base portion and a series of projections. The base portion is substantially flat and has an upper surface and a lower surface. The series of projections extends upward from the upper surface. Each projection has a base and has a height greater than 0.125 inch. The base portion and the projections are formed of a material that is rigid and non-conductive.

In some of these embodiments, each projection can define a cavity such that the projection has a hollow interior. Each projection can be pointed so as to provide a non-slip surface and can be not sharp, so as to prevent punctures in rubber overshoes. Generally, each projection can be conical or pyramid in shape with the base of the projection being at the base portion.

In the embodiments, the base can be about double the height. Further, the base can be from about 0.25 inch to about 2 inches and the height is from 0.125 inch to about 1 inch. Optionally, the base can be from about 0.5 inch to about 1.5 inches and the height can be from about 0.25 inch to about 0.75 inch, or the base can be from about 0.75 inch to about 1.25 inches and the height from about 0.4 inch to about 0.6 inch.

In certain embodiments, the series of projections forms a plurality of rows and columns with at least one of the rows and columns being offset so as to form diagonal channels.

In any of the above embodiments, the step can further comprise a ledge on a bucket of a bucket truck, and the lower surface of the base can be affixed to the ledge. In such embodiments, the step can further comprise an adhesive which affixes the lower surface to the ledge. In some embodiments, the ledge can be made of fiberglass, the base and cones can be made of acrylonitrile butadiene styrene, and the adhesive can be a methacrylate adhesive.

In accordance with another series of embodiments, there is provided a process comprising the steps of:
(a) applying an adhesive to at least a portion of a ledge to form an adhesive coated ledge;
(b) shaping a mold to the size of the ledge to form a shaped mold, wherein the mold comprises;
   a base portion that is substantially flat and having an upper surface and a lower surface; and
   a series of projections extending upward from the upper surface, each of the projections being conical or pyramid in shape, and wherein the base portion and the projections are formed of a material that is rigid and non-conductive; and
(c) applying the shaped mold to the ledge such that the adhesive bonds the shaped mold to the ledge.

In some embodiments, the process further comprises preparing the ledge by cleaning residue from the ledge prior to step (a). The ledge can be made of fiberglass and the step of preparing the ledge can comprise removing any tape or enamel by using a wire brush, mini grinder, or sander to expose the fiberglass for the portion of the ledge.

In some of the embodiments, the mold can be made of acrylonitrile butadiene styrene, and the adhesive can be a methacrylate adhesive.

In some applications of the process, the step of shaping the mold can further comprise the steps of:
placing a template material on the portion of the ledge prior to step (a);
tracing an area on the template material such that the area is at least as large as the portion of the ledge but is not larger than the ledge;
cutting the area out of the template material to form a template;
placing the template on the lower surface of the mold so the area of the template includes as many projections as possible;
cutting the mold based on the template to produce a sized mold, wherein the cutting is between cones;
placing the mold on the ledge; and
if the sized mold is larger than the ledge, trimming the sized mold by cutting through the cones so as to produce a trimmed mold that covers the portion of the ledge.

In the above embodiments of the process, each projection can define a cavity such that the projection has a hollow interior. Additionally, in the process the series of projections can form a plurality of rows and columns with at least one of the rows and columns being offset so as to form diagonal channels. Also, each projection can form a point distal from the base with the base being at the upper surface of the base portion. Typically, the points are not sharp so as to prevent punctures in rubber overshoes. Further, the base is about double the height with the base being from about 0.25 inch to about 2 inches.

### BRIEF DESCRIPTION OF THE DRAWINGS

FIG. 1 is a side view of a safety bucket employing a safety step in accordance with an embodiment.

FIG. 2 is a perspective view of a mold useful in a safety step in accordance with an embodiment.

FIG. 3 is a top view of the mold illustrated in FIG. 2.

FIG. 4 is a front view along line 4-4 of FIG. 3.

FIG. 5 is a cross-sectional view along line 5-5 of FIG. 3.

FIG. 6 is an enlargement of a section of FIG. 3.

FIG. 7 is an illustration of a conical projection useful in some embodiments.

FIG. 8 is an illustration of a pyramid projection useful in some embodiments.

### DETAILED DESCRIPTION

In the description that follows, like parts are marked throughout the specification and drawings with the same reference numerals, respectively. The drawings are not necessarily to scale and the proportions of certain parts have been exaggerated to better illustrate details and features of the invention. In the following description, the terms “inwardly” and “outwardly” are directions toward and away from, respectively, the geometric axis of a referenced object. Where components of relatively well-known designs are employed, their structure and operation will not be described in detail.

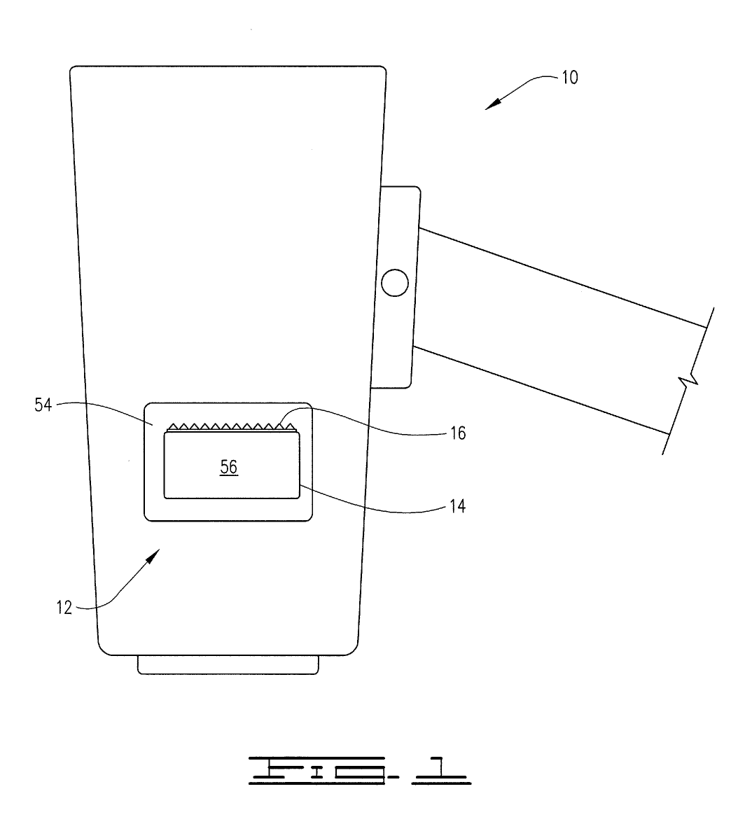

Referring now to FIG. 1, there is shown a safety bucket 10 of the type that can be used to raise workers to perform task. Safety bucket 10 has a safety step 12 in accordance with this disclosure. Generally, safety step 12 is on a safety bucket as shown; however, the step can be on any equipment or structure where slippage is a concern. Safety step 12 is especially useful where both slippage and electrical shock are concerns. Safety step 12 generally comprises a ledge 14 forming a part of the bucket, equipment or structure and a mold 16. Ledge 14, as shown in the figures, is generally a step formed as part of the bucket, equipment or structure and forms a part of the safety step after mold 16 is attached thereto. The current safety step is especially useful where ledge 14 is formed from fiberglass, such as on safety buckets where fiberglass is used to limit conductivity.

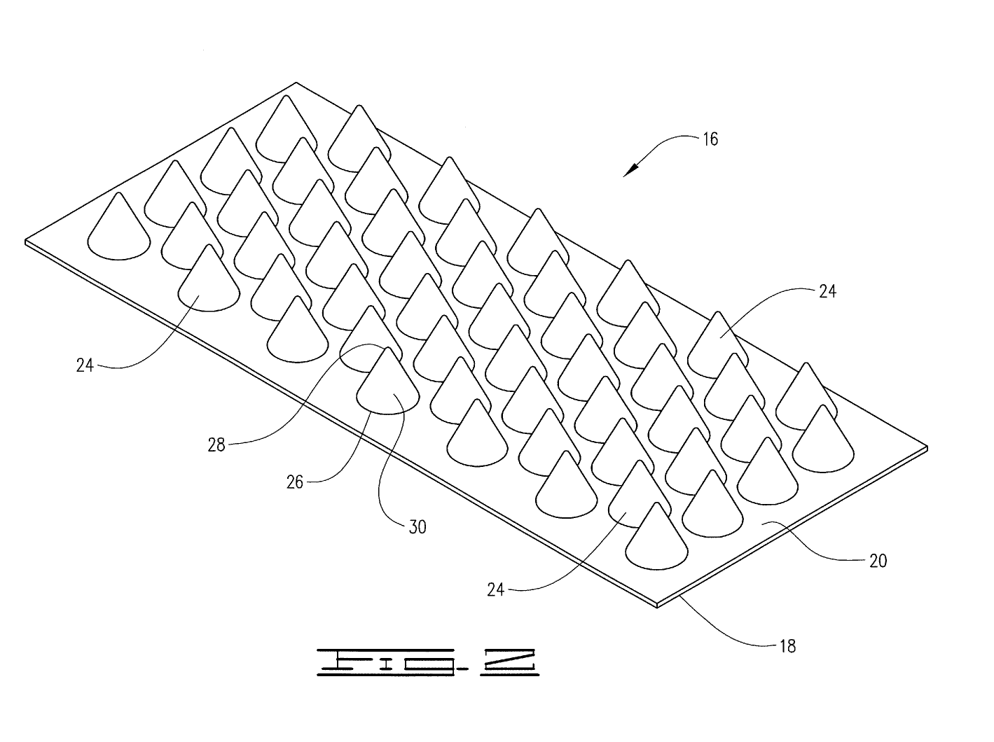

Mold 16 is typically formed of a material that is rigid and non-conductive. As can better be seen from FIGS. 2, 3 and 4, mold 16 comprises a base portion 18 and a series of projections 24. Base portion 18 can be flat and have an upper surface 20 and a lower surface 22. Projections 24 comprise a base 26 and a distal end 28. In currently preferred embodiments, distal end 28 is configured to be a point distal from base 26. Projections 24 extend upward from upper surface 20 such that base 26 is in contact with upper surface 20. Generally, projections 24 will be integrally formed with base portion 18 such as by molding base portion 18 and projections 24 as a single unit in an injection molding, compression molding or similar plastic molding process.

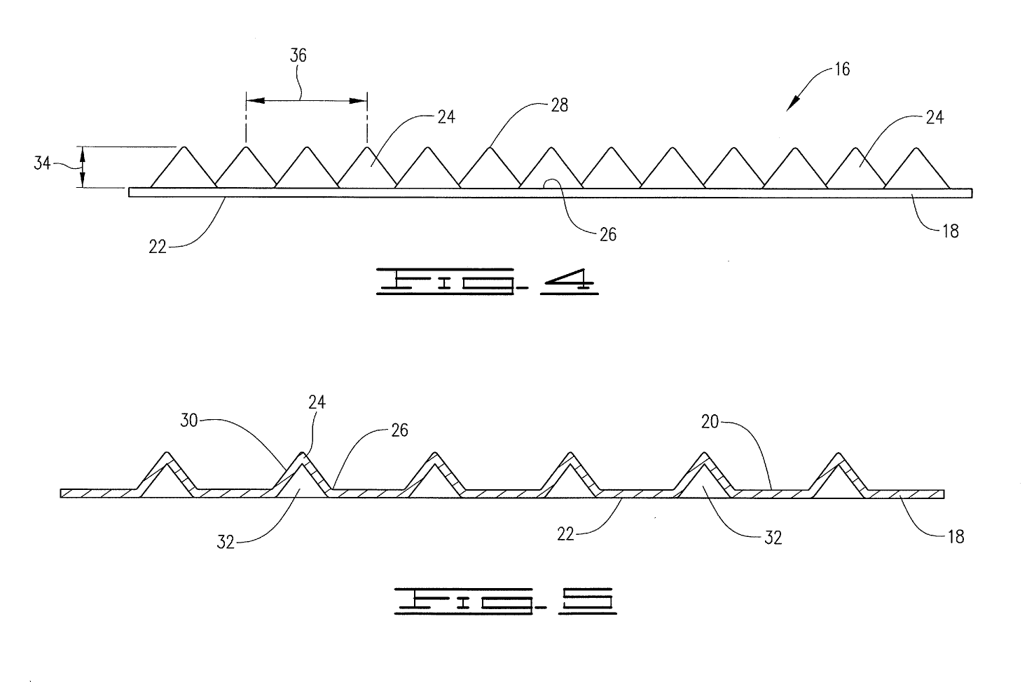

As can best be seen from FIG. 5, projections 24 have a wall 30 extending from base 26 to distal end 28. Wall 30 defines a cavity 32 such that projections 24 have a hollow interior. Cavity 32 serves to create an air pocket when mold 16 is mounted or secured to ledge 14. Thus, under each projection 24 there is an air space between the mold and ledge. It has been found that this air space along with the material of construction of the mold and with the uneven service created by the projections produces a “density change” between the bucket and those contaminants that routinely appear on the step, such as snow, ice, mud and similar. This “density change” effects how such contaminants adhere to the safety step, thus aiding in the safety step's ability to be easily cleared from these contaminants. For example, ice adhering to the mold is cleared much easier with existing mechanical and vibrational force than for prior art nonskid surfaces.

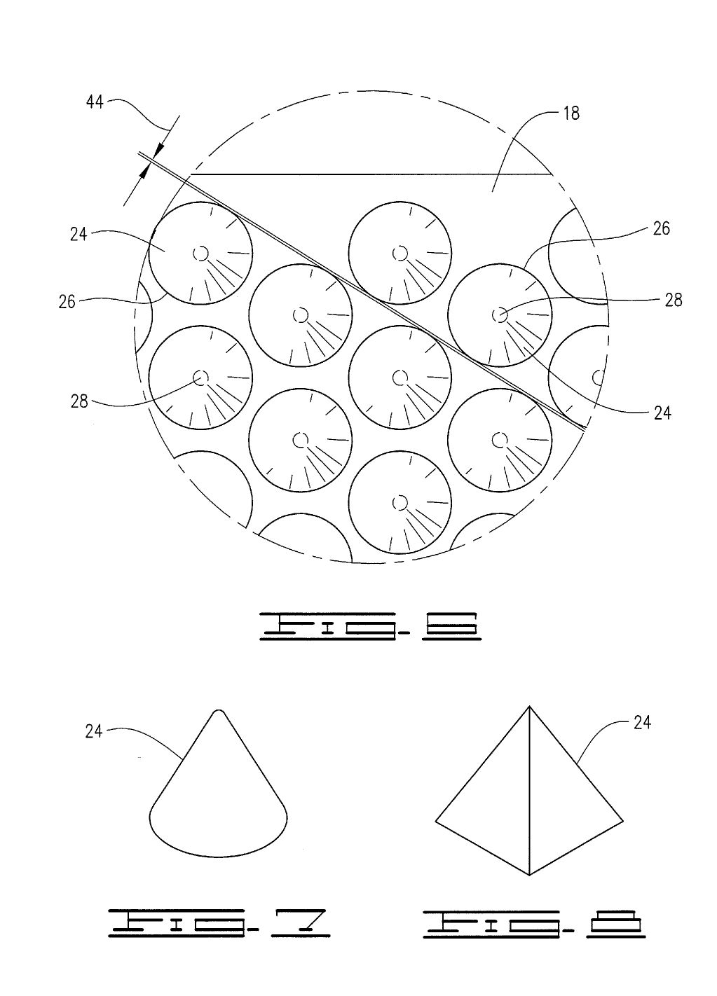

Further, the inventor has discovered that pointed projections 24 that are not sharp are particularly advantageous in use in safety steps. “Sharp” refers to having an edge or point able to cut or pierce rubber, leather, or a similar boot or shoe material or fabric. While not wishing to be bound by theory, it is believed that pointed but not sharp projections provide for enhanced traction with the shoe of the worker while decreasing the possibility of penetration or puncturing into rubber overshoes, which workers use to reduce electrical shock risk. As can be seen from FIGS. 6 and 7, projections 24 typically are conical in shape or have a pyramid shape; however, projections 24 can be other shapes such as cylindrical, domed, star-shaped or similar but preferably will have a raised point. Additionally, if a pyramid shape is used, the pyramid can have a base and three sides, four sides, or more sides.

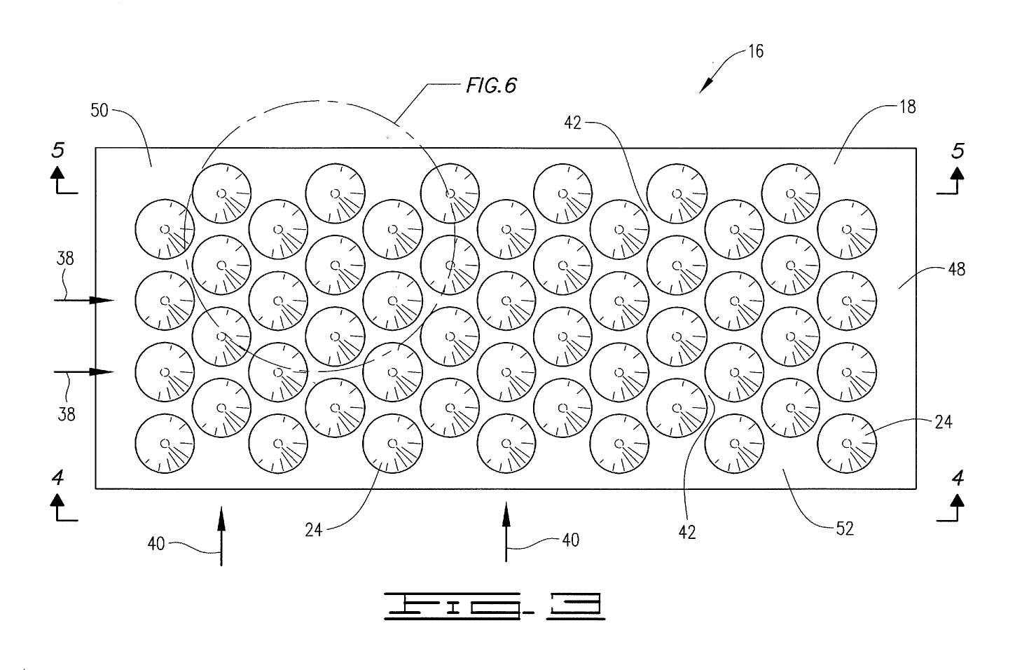

Additionally, the inventor has discovered that the size of the conical projections are critical for ensuring maximum traction for the worker while reducing risk of conductors laying on the step and thus contacting the worker as his foot contacts the step or the conductor being retained on the step and thus contacting the equipment or bucket, as further described below. As seen from FIG. 4, projections 24 will typically have a height 34 greater than 0.125 inch, wherein the base portion and the projections are formed of a material that is rigid and non-conductive. Generally, base width 36 is about twice height 34. Often base width 36 is from about 150% to about 250% of height 34, 175% to 125% of height 34, 190% to 110% of height 34, or 195% to 205% of height 34. Also, typical dimensions for base width 36 of the conical or pyramid shaped projections are from about 0.25 inch to about 2 inches, optionally from about 0.5 inch to about 1.5 inches, or optionally from about 0.75 inch to about 1.25 inches. Typical dimensions for height 34 of conical or pyramid shape projections are from 0.125 inch to about 1 inch, optionally from about 0.25 inch to about 0.75 inch, or optionally from about 0.4 inch to about 0.6 inch. For example, the conical projections can have a 1-inch base diameter or width and have a height of 0.5 inch.

As can be seen from FIGS. 3 and 6, in one embodiment projections 24 form a plurality of rows 38 and columns 40 with at least one of the rows and columns being offset so as to form diagonal channels 42. Rows 38 run from edge 46 to opposing edge 48 and are substantially parallel to each other. Columns 40 run from edge 50 to opposing edge 52 and are substantially parallel to each other. Generally, projections can be arranged such that there are no straight channels between the rows 38 or the columns 40; that is, a straight rod or wire cannot lie in the channels running from edge 46 to edge 48 or from edge 50 to edge 52. Further, it is currently preferred to have diagonal channels 42 be as narrow as possible. Typically, at the closest position between projections each diagonal channel 42 will have a width 44 of less than about 0.25 inch or less than about 0.125 inch as measured from the base of the cones (see FIG. 6). This positioning of the projections provides a configuration that will prevent small or large conductors to lay in the grooves or channels and thereby eliminate unintended conductor movement while a worker is maneuvering in or out of the bucket or around electrical poles near the bucket. For example, if the application is a step on the wall of a utility bucket (as shown in FIG. 1), the diagonal channels will extend from wall 54 of bucket 10 to the distal surface 56 of the ledge 14. Thus, the diagonal channels created lead away from the bucket and, a conductor line will not catch in the channel because it would have to extend through the bucket wall to do so. Additionally, sleet, snow, mud, sawdust, liquids and fine particles introduced into the channels from the projections are channeled away and off the step. Accordingly, while the step provides a traction catch for the boot of a worker, the step is not a catch point for conductor lines or other loose matter; rather, such matter slides off the step. This leaves the points exposed for maximum traction and prevents buildup of conductive liquids and fine particles, which might form an electrical hazard.

Generally, the mold can be manufactured of a polymer that is rigid and nonconductive. Currently preferred is acrylonitrile butadiene styrene, or ABS. Often used to make car bodies, appliances, musical instruments, plastic pipe, and much more. This tough, lightweight, co-polymer is the currently preferred choice for the design chosen to ensure maximum traction for the worker. ABS co-polymer is electrically non-conductive and impervious to hot or cold temperatures, as well as sunlight's UV rays.

The mold is generally adhered to the ledge of the bucket, equipment or structure using a structural adhesive that is fast setting, tough, and easy to use. It has been found that methacrylate adhesives are especially useful for this purpose. One example of a suitable methacrylate adhesive is marketed under the designation 55305 of the Maximum Performance Series by Adhesive Systems Inc. Critical tests have resulted in zero failures of the 55305 adhesive provided for use with the disclosed safety step.

Generally, the mold can be attached to the bucket by any suitable process. In accordance with this disclosure, the ledge, or bucket step, can be first prepared by cleaning any residue from the ledge, such as by removing all of the non-skid tape, the epoxy (the thin smooth white coating applied over the fiberglass) and any other dirt, debris or other residue. A wire brush, mini grinder, or sander can be used to expose the entire area of the top surface of the step down to the fiberglass.

Either before or after cleaning of the ledge, but preferably after cleaning, a template is created. To create a template, cardboard or something similar is placed on top of the bucket step or ledge to cover the exposed fiberglass area. With a paint pen, indelible marker or other suitable marker, an outline is traced around the bucket step onto the cardboard.

Next, the template is cut out and placed on the mold. The template is positioned on the underneath side of the mold over as many cones or projections as possible. If the width (side to side) of the cone area is wider than the ledge width, trim through the rows of cones as needed and center the mold on the bucket step. If the depth of the mold, (front to back) is deeper than the bucket step, trim through the cones as needed and place that cut at the back of the bucket step, against the side of the bucket. The trimming of the mold thus produces a shaped mold of the proper size for the ledge.

To affix the shaped mold to the ledge, an adhesive can be applied to the portion of the ledge that will be covered by the shaped mold. Subsequently, the shaped mold is applied to the ledge such that the adhesive bonds the shaped mold to the ledge.

The above elements of the safety step as well as others can be seen with reference to the figures. From the above description and figures, it will be seen that the present invention is well adapted to carry out the ends and advantages mentioned, as well as those inherent therein. While the presently preferred embodiment of the apparatus has been shown for the purposes of this disclosure, those skilled in the art may make numerous changes in the arrangement and construction of parts. All of such changes are encompassed within the scope and spirit of the appended claims.

What is claimed is:

1. A step comprising:
a base portion that is substantially flat and having an upper surface and a lower surface; and
a series of projections extending upward from said upper surface, each of the projections having a base and having a height greater than 0.125 inch, wherein said base portion and said projections are formed of a material that is rigid and non-conductive.

2. The step of claim 1, wherein each said projection defines a cavity such that said projection has a hollow interior.

3. The step of claim 1, wherein each said projection is pointed so as to provide a non-slip surface and is not sharp, so as to prevent punctures in rubber overshoes.

4. The step of claim 1, wherein each said projection is conical or pyramid in shape with said base of the projection being at said base portion.

5. The step of claim 4, wherein said base is about double said height.

6. The step of claim 4, wherein said base is from about 0.25 inch to about 2 inches and said height is from 0.125 inch to about 1 inch.

7. The step of claim 1, wherein said series of projections forms a plurality of rows and columns with at least one of said rows and columns being offset so as to form diagonal channels.

8. The step of claim 7, wherein said projections are conical or pyramid in shape so as to form a point distal from said base with said base being at the upper surface of said base portion, and wherein said points are not sharp so as to prevent punctures in rubber overshoes, and said projections define a cavity such that said projections have a hollow interior.

9. The step of claim 8, wherein said base is about double said height.

10. The step of claim 1, further comprising a ledge on a bucket of a bucket truck, said lower surface of said base being affixed to said ledge.

11. The step of claim 10, further comprising an adhesive which affixes said lower surface to said ledge.

12. The step of claim 11, wherein said ledge is made of fiberglass, said base and cones are made of acrylonitrile butadiene styrene, and said adhesive is a methacrylate adhesive.

13. The step of claim 12, wherein:
said series of projections forms a plurality of rows and columns with at least one of said rows and columns being offset so as to form diagonal channels;
said projections are conical or pyramid in shape so as to form a point distal from said base with said base being at the upper surface of said base portion;
said points are not sharp so as to prevent punctures in rubber overshoes;
said projections define a cavity such that said projections have a hollow interior; and
said base is about double said height with said base being from about 0.25 inch to about 2 inches.

14. A process comprising:
(a) applying an adhesive to at least a portion of a ledge to form an adhesive coated ledge;
(b) shaping a mold to the size of the ledge to form a shaped mold, wherein said mold comprises:
a base portion that is substantially flat and having an upper surface and a lower surface; and
a series of projections extending upward from said upper surface, each of said projections being conical or pyramid in shape, and wherein said base portion and said projections are formed of a material that is rigid and non-conductive; and
(c) applying said shaped mold to said ledge such that said adhesive bonds said shaped mold to said ledge.

15. The process of claim 14, wherein prior to step a, the process further comprises preparing said ledge by cleaning residue from said ledge.

16. The process of claim 15, wherein said ledge is made of fiberglass and the step of preparing said ledge comprises removing any tape or enamel by using a wire brush, mini grinder, or sander to expose said fiberglass for said portion of said ledge.

17. The process of claim 16, wherein said mold is made of acrylonitrile butadiene styrene, and said adhesive is a methacrylate adhesive.

18. The process of claim 17, wherein said step of shaping said mold further comprises:
placing a template material on said portion of said ledge prior to step (a);
tracing an area on said template material such that said area is at least as large as said portion of said ledge but is not larger than said ledge;
cutting said area out of said template material to form a template;
placing said template on said lower surface of said mold so said area of said template includes as many projections as possible;
cutting said mold based on said template to produce a sized mold, wherein said cutting is between cones;
placing said mold on said ledge; and
if said sized mold is larger than said ledge, trimming said sized mold by cutting through said cones so as to produce a trimmed mold that covers said portion of said ledge.

19. The process of claim 18, wherein each projection defines a cavity such that said projection has a hollow interior.

20. The process of claim 19, wherein:
said series of projections forms a plurality of rows and columns with at least one of said rows and columns being offset so as to form diagonal channels;
each projection forms a point distal from said base with said base being at the upper surface of said base portion;
said points are not sharp so as to prevent punctures in rubber overshoes; and
said base is about double said height with said base being from about 0.25 inch to about 2 inches.
